(19) United States
(12) Patent Application Publication
(10) Pub. No.: US 2025/0036183 A1
(43) Pub. Date: Jan. 30, 2025

(54) System and Method for Tracking and Controlling Battery Consumption in Fleets of Electronic Devices Powered by Batteries

(71) Applicant: ZEBRA TECHNOLOGIES CORPORATION, Lincolnshire, IL (US)

(72) Inventors: Charles W. Roark, Frisco, TX (US); Wayne A. Miller, Mt. Sinai, NY (US)

(21) Appl. No.: 18/227,245

(22) Filed: Jul. 27, 2023

(51) Int. Cl. G06F 1/3212

(52) U.S. Cl. CPC G06F 1/3212

(57) ABSTRACT

Systems and methods for tracking and controlling battery consumption in fleets of electronic devices powered by batteries are disclosed herein. An example method includes receiving power consumption and usage information of a device over a duration of time; determining a first power usage value of the device based on the power consumption and usage information over the duration; analyzing the power consumption and usage information to determine an attribute associated with excess power usage of the device over the duration; identifying and applying a mitigation to address the attribute and to decrease the first power usage value over the duration; determining a second power usage value of the device based on the implemented mitigation over the duration; determining a difference between the first and second power usage values over the duration; and determining at least one metric indicative of power conservation over the duration based on the determined difference.

### BACKGROUND

Environmental, social, and corporate governance (ESG) impact metrics are becoming an important factor in client and consumer choices. Improving the environmental impact component involves, for instance, moving toward carbon neutrality and reducing emissions and the use of landfills. However, this environmental impact is often evaluated qualitatively rather than quantitatively, so it can be difficult to determine where an organization stands with respect to these metrics. Consequently, a way to evaluate these metrics quantitatively is needed, particularly with respect to the environmental impact of battery consumption and disposal by mobile devices such as mobile computers and symbology readers, as well robotic devices.

### SUMMARY

In an embodiment, the present invention is a method comprising receiving power consumption information of a device and usage information of the device over a duration of time; determining a first power usage value of the device for the duration of time based on the power consumption information and the usage information over the duration of time; analyzing the power consumption information and the usage information to determine at least one attribute associated with excess power usage of the device over the duration of time; identifying and applying at least one mitigation to address the at least one attribute and to decrease the first power usage value over the duration of time; determining a second power usage value of the device based on the implemented at least one mitigation over the duration of time; determining a difference between the first power usage value and the second power usage value over the duration of time; and determining at least one metric indicative of power conservation over the duration of time based on the determined difference.

In a variation of this embodiment, the power consumption information includes battery charge data over the duration of time.

Furthermore, in a variation of this embodiment, the usage information includes one or more of: a battery discharge rate, a screen on time, screen brightness data, a scan rate, usage data associated with one or more business applications installed on the device, a battery cycle, a battery charge level, a battery temperature, a battery present capacity, a battery total cumulative charge, a battery rated capacity, an average current, an average power, a voltage, charge on/off events, a battery charge source, or battery swap data, over the duration of time.

Moreover, in a variation of this embodiment, determining the first power usage value of the device for the duration of time is further based on one or more of: a battery type, a battery health, a device type, a device screen timeout setting, a device brightness setting, battery cycle, a battery charge level, a battery temperature, a battery present capacity, a battery total cumulative charge, a battery rated capacity, an average current, an average power, a voltage, charge on/off events, a battery charge source, or a site name, associated with the device.

Additionally, in a variation of this embodiment, the first power usage value is a minimum battery charge required over the duration of time.

Furthermore, in a variation of this embodiment, the at least one attribute associated with the excess power usage of the device over the duration of time includes one or more of: a screen brightness attribute, a screen on time attribute, a wireless signal strength attribute, a device location attribute, a device physical memory attribute, an application physical memory utilization attribute, a battery per application utilization attribute, a scanner usage attribute, a data transmission attribute associated with the device, a data transmission per application attribute, a reception usage attribute associated with the device, and a reception usage per application attribute.

Moreover, in a variation of this embodiment, the at least one mitigation includes one or more of: a screen brightness reduction, a screen on time reduction, increasing wireless signal strength quality, improving memory utilization associated with the device, improving memory utilization per application, reducing battery usage per application, optimizing data transmission, optimizing reception, or optimizing scanner usage.

Additionally, in a variation of this embodiment, the at least one metric indicative of power conservation over the duration of time includes one or more of: a battery life metric, a battery purchasing metric, a battery disposal metric, a power consumption metric, a CO2 emission rate metric, or a precious metal mining rate metric.

Furthermore, in a variation of this embodiment, the duration of time is a duration associated with a work shift.

In another embodiment, the present invention is a device including: a smart battery including a battery memory and one or more battery processors storing first computer-readable instructions that cause the one or more battery processors to store battery usage and state of charge (SOC) data on the battery memory; a clock, a device communication system, one or more device processors, and a device memory storing second computer-readable instructions; and a server including a server communication system, one or more server processors, and a server memory storing third computer-readable instructions; wherein the second computer-readable instructions, when executed by the one or more device processors, cause the one or more device processors to: detect events associated with the battery; compile event data based on the detected events, the event data including, for each of one or more detected events, one or more of: battery usage data stored on the battery memory associated with the event, SOC data stored on the memory associated with the event, an indication of an event type associated with the event, a time associated with the event, an indication of a backup voltage level during the event, a battery temperature associated with the event, a battery cumulative charge at the time of the event, or a battery charge source associated with the event; and transmit the compiled event data to the server, via the device communication system; wherein the third computer-readable instructions, when executed by the one or more server processors, cause the one or more server processors to: receive the compiled event data from the device, via the server communication system; determine device activity data associated with the device based on the compiled event data; and analyze the device activity data using an electrical consumption model to estimate electrical consumption for the device based on battery consumption associated with the device.

In a variation of this embodiment, the device is one of: a mobile computing device, a mobile printer, a scanner device, and a robot device.

Moreover, in a variation of this embodiment, the second computer-readable instructions, when executed by the one or more device processors, further cause the one or more device processors to: capture additional device data including one or more of: power usage data associated with the device, a screen on time associated with the device, screen brightness data associated with the device, a scan rate associated with the device, usage data associated with one or more business applications installed on the device, a wireless signal strength associated with the device, a device location, an indication of device physical memory utilization, an indication of physical memory utilization per application, an indication of battery utilization per application, an indication of data transmission associated with the device, an indication of data transmission per application, an indication of reception usage associated with the device, or an indication of reception usage per application; and transmit, via the device communication system, the additional device data to the server.

Furthermore, in a variation of this embodiment, the third computer-readable instructions, when executed by the one or more server processors, further cause the one or more server processors to: receive the additional device data, via the server communication system; and determine the device activity data based further on the additional device data.

Additionally, in a variation of this embodiment, the third computer-readable instructions, when executed by the one or more server processors, further cause the one or more server processors to: determine at least one metric associated with the estimated electrical consumption, the at least one metric including one or more of: an emission rate, a precious metal mining rate, or a landfill rate.

Furthermore, in a variation of this embodiment, the detected events associated with the battery include one or more of: a low battery event battery, a battery swap mode event, a battery swap entry event, a battery swap exit event, a battery change on event, a battery charge off event, a battery status event, a battery temperature event, a battery cumulative charge event, a device suspend event, a device suspend recovery event, or a device shutdown event.

In still another embodiment, the present invention is a system comprising: a mobile device including a battery, a clock, a mobile device communication system, one or more mobile device processors, and a mobile device memory storing first computer-readable instructions that, when executed by the one or more mobile device processors, cause the one or more mobile device processors to collect and transmit mobile device data, including battery and usage status data, via the mobile device communication system; a server including a server communication system, one or more server processors, and a server memory storing second computer-readable instructions that, when executed by the one or more server processors, cause the one or more server processors to: receive mobile device data, via the server communication system; analyze the mobile device data to determine one or more of: durations of one or more shifts associated with the mobile device, a required power consumption associated with the mobile device, a measured power consumption associated with the mobile device, a predicted power consumption over time associated with the mobile device, a predicted rate of battery purchases associated with the mobile device, a predicted rate of battery disposals associated with the mobile device, a predicted impact of a power consumption of the mobile device on emission rates, or a predicted impact of a power consumption of the mobile device on landfill rates.

In a variation of this embodiment, the mobile device is one of: a mobile computing device, a mobile printer, a scanner device, or a robot device.

Moreover, in a variation of this embodiment, the battery is a lithium-ion battery.

Furthermore, in a variation of this embodiment, analyzing the mobile device data includes analyzing the mobile device data using one or more machine learning algorithms.

Additionally, in a variation of this embodiment, analyzing the mobile device data includes analyzing the mobile device data using one or more simulations.

Moreover, in a variation of this embodiment, the one or more simulations include a Monte-Carlo simulation.

Furthermore, in a variation of this embodiment, the second computer-readable instructions, when executed by the one or more server processors, further cause the one or more server processors to: identify one or more mobile device setting changes, improvements in wireless coverage, application updates, application memory usage changes, application battery usage changes, or behavioral changes impacting the power consumption associated with the mobile device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example system for tracking and controlling battery consumption in fleets of electronic devices powered by batteries, in accordance with some embodiments.

FIG. 2 is a block diagram associated with an example electronic device as may be used in the system of FIG. 1, in accordance with some embodiments.

FIG. 3 is a block diagram of an example server as may be used in the system of FIG. 1, in accordance with some embodiments.

FIGS. 4-7 are flow diagrams of example processes for implementing example methods and/or operations described herein including techniques for tracking and controlling battery consumption in fleets of electronic devices powered by batteries, as may be performed by the system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### Overview

As discussed above, environmental, social, and corporate governance (ESG) impact metrics are becoming an important factor in client and consumer choices. Improving the environmental impact component involves, for instance, moving toward carbon neutrality and reducing emissions and the use of landfills. However, this environmental impact is often evaluated qualitatively rather than quantitatively, so it can be difficult to determine where an organization stands with respect to these metrics. Consequently, a way to evaluate these metrics quantitatively is needed, particularly with respect to the environmental impact of battery consumption and disposal by mobile devices such as mobile computers and symbology readers, as well robotic devices.

The present disclosure provides techniques for determining battery-related power consumption for devices in baseline use, measuring changes in battery-related power consumption when various power savings approaches are implemented, and providing mechanisms to increase battery life and thus decrease the number of batteries needing recycling or disposal. Furthermore, the present disclosure determines and provides metrics illustrating the impact of these changes, such as, for instance, the weight reduction of disposed batteries in landfills when such changes are made. Determining such metrics numerically may allow an organization to make quantitative ESG impact statements related to the power consumption of mobile devices with batteries, particularly with respect to how reducing power consumption requirements of devices can reduce an organization's carbon footprint, and increasing the health and useful life of batteries used by such devices reduce the impact of battery disposal on landfills.

### Example System

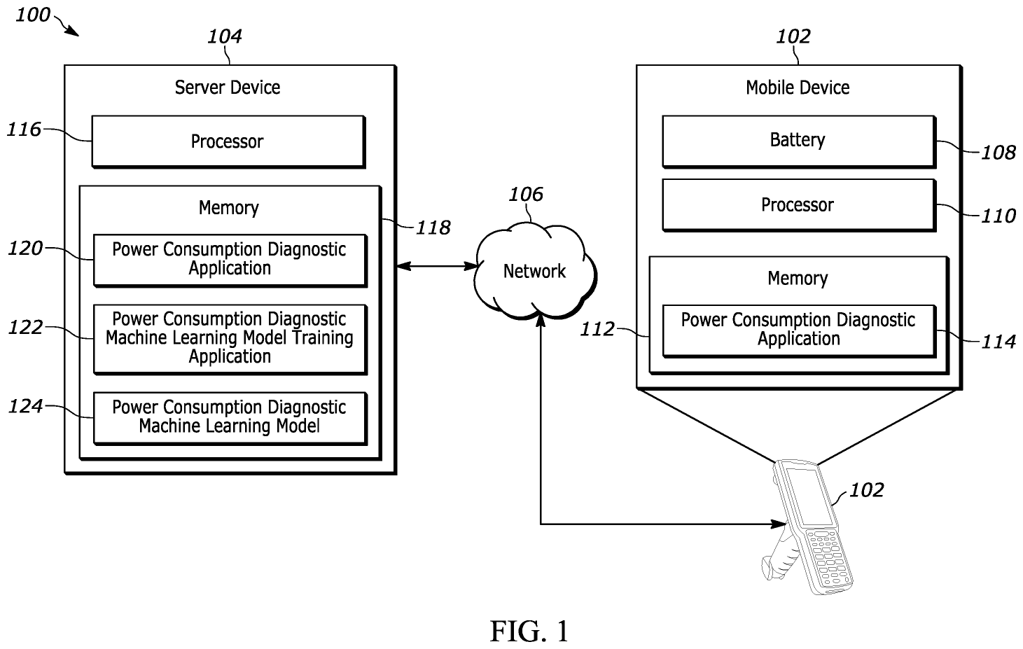

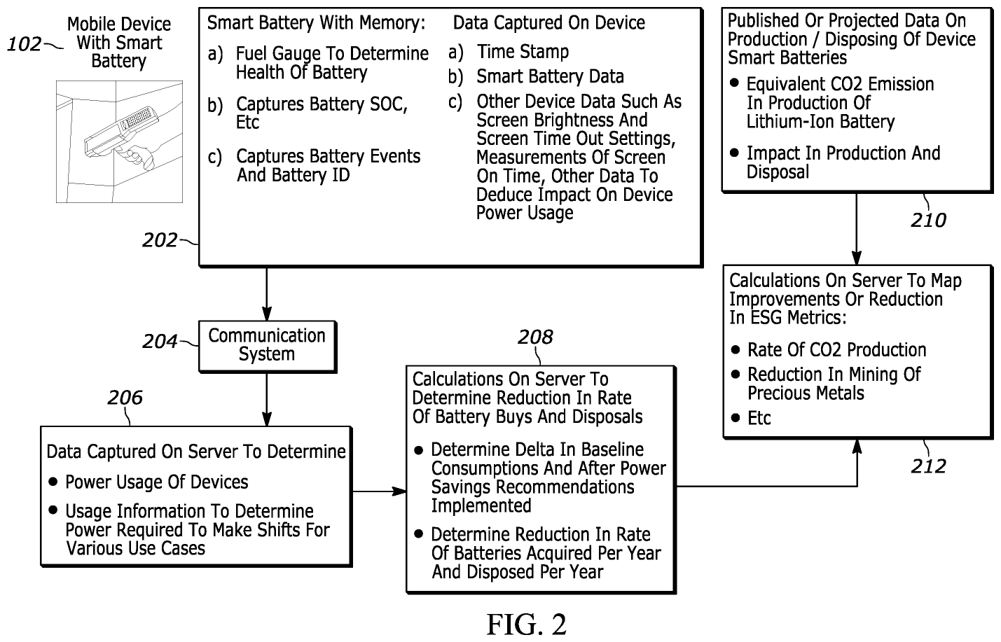

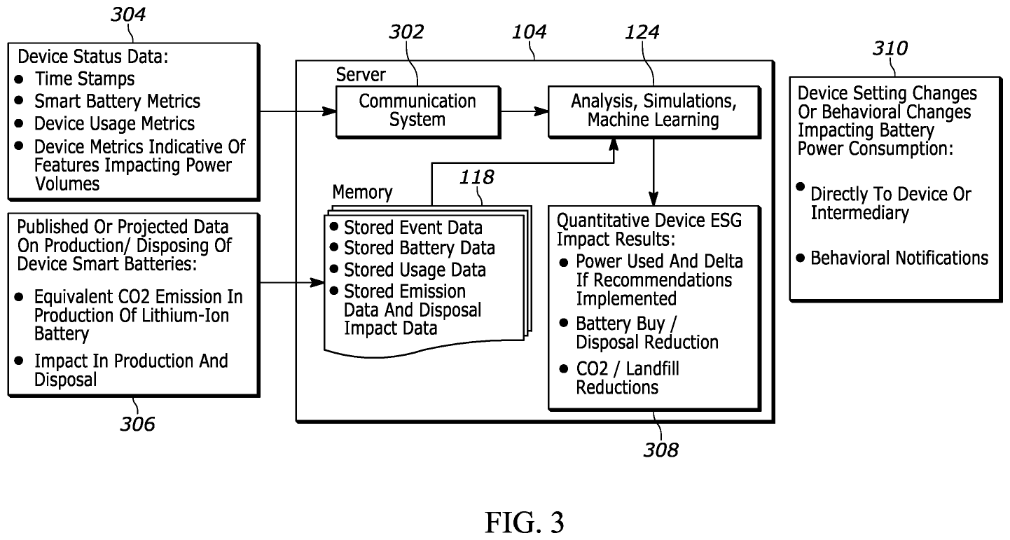

FIG. 1 illustrates an example system 100 for tracking and controlling battery consumption in fleets of electronic devices powered by batteries. In the illustrated example, the system 100 includes one or more electronic devices 102, which may communicate with a server device 104 via a network 106 (and/or via a wired interface, not shown). FIGS. 2 and 3 provide additional detail related to the electronic devices 102 and server devices 104.

The electronic devices 102 may be mobile computing devices, such as, e.g., smart phones, smart watches, tablets, and laptop computers, as well as specialized mobile computing devices such as bar code readers, QR-code scanners, RFID readers, robotic devices, etc. Generally speaking, each of the electronic devices 102 may include a network interface (not shown) that represents any suitable type of communication interface(s) (e.g., wired interfaces such as Ethernet or USB, and/or any suitable wireless interfaces) configured to operate in accordance with any suitable protocol(s) for communicating with the server 104 over the network 106. Moreover, each of the devices 102 may include a battery 108. In some examples, the battery 108 may be a lithium-ion battery. Furthermore, in some examples, the battery 108 may be a smart battery including a battery memory and one or more battery processors storing computer-readable instructions that cause the one or more battery processors to store battery usage and state of charge (SOC) data on the battery memory.

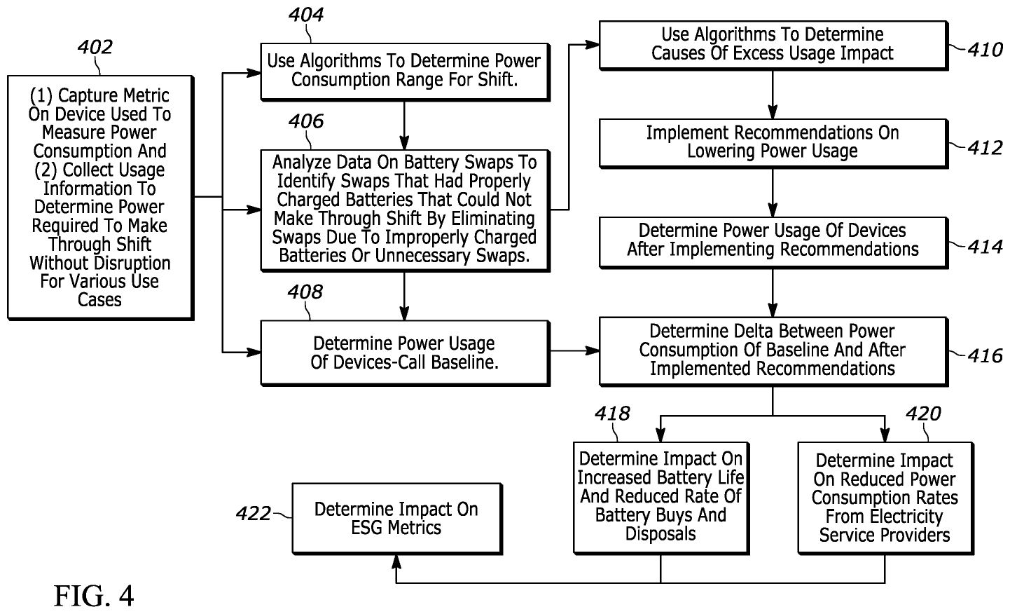

Furthermore, each of the devices 102 may include one or more processors 110, which may be, for example, one or more microprocessors, controllers, and/or any suitable type of processors, and a memory 112 accessible by the one or more processors 110 (e.g., via a memory controller). An example processor 110 may interact with the memory 112 to obtain, for example, machine-readable instructions stored in the memory 112 corresponding to, for example, the operations represented by the flowcharts of this disclosure, including those of FIGS. 4-7. For instance, the instructions stored in the memory 112, may cause the processor 110 to execute various applications stored in the memory 112, such as a power consumption diagnostic application 114.

Executing the power consumption diagnostic application 114 may include causing the mobile device 102 to capture or otherwise obtain device data, and transmit the device data to the server 104, e.g., via one of the communication interfaces mentioned above. For instance, the mobile device data may include battery usage data, battery status data, etc., associated with the battery 108 of the mobile device. In some examples, for instance, when the battery 108 is a smart battery, the mobile device 102 may obtain some portion of the device data from the battery 108. Moreover, in some examples, executing the power consumption diagnostic application 114 may cause the mobile computing device 102 to capture additional device data and transmit the additional device data to the server 104. For instance, the additional device data may include one or more of: power usage data associated with the device, a screen on time associated with the device, screen brightness data associated with the device, a scan rate associated with the device, usage data associated with one or more business applications installed on the device, a wireless signal strength associated with the device, a device location, an indication of device physical memory utilization, an indication of physical memory utilization per application, an indication of battery utilization per application, an indication of data transmission associated with the device, an indication of data transmission per application, an indication of reception usage associated with the device, or an indication of reception usage per application.

Moreover, in some examples, executing the power consumption diagnostic application 114 may cause the mobile computing device 102 to detect events associated with the battery, compile event data based on the detected events, and transmit the compiled event data to the server. For example, the detected events associated with the battery may include one or more of: a low battery event, a battery swap mode event, a battery swap entry event, a battery swap exit event, a battery change on event, a battery charge off event, a battery status event, a battery temperature event, a battery cumulative charge event, a device suspend event, a device suspend recovery event, or a device shutdown event. For a given event, the event data may include one or more of: battery usage data stored on the battery memory associated with the event, SOC data stored on the memory associated with the event, an indication of an event type associated with the event, a time associated with the event, an indication of a backup voltage level during the event, a battery temperature associated with the event, a battery cumulative charge at the time of the event, or a battery charge source associated with the event.

The server 104 may include one or more processors 116, which may be, for example, one or more microprocessors, controllers, and/or any suitable type of processors, and a memory 118 accessible by the one or more processors 116 (e.g., via a memory controller). An example processor 116 may interact with the memory 118 to obtain, for example, machine-readable instructions stored in the memory 118 corresponding to, for example, the operations represented by the flowcharts of this disclosure, including those of FIGS. 4-7. For instance, the instructions stored in the memory 118, when executed by the processor 116, may cause the processor 116 to execute various applications stored in the memory 118, such as a power consumption diagnostic application 120, a power consumption diagnostic machine learning model training application 122, and a power consumption diagnostic machine learning model 124.

Executing the power consumption diagnostic application 120 may include, in an example, receiving the device data, additional device data, and/or compiled event data from the mobile computing device 102 (e.g., via the network 106). For instance, the power consumption diagnostic application 120 may analyze the device data, and/or the additional device data (e.g., using a simulation, such as a Monte-Carlo simulation, and/or using a machine learning model, such as the power consumption diagnostic machine learning model 124 discussed in greater detail below), to determine one or more of: durations of one or more shifts associated with the mobile device, a required power consumption associated with the mobile device, a measured power consumption associated with the mobile device, a predicted power consumption over time associated with the mobile device, a predicted rate of battery purchases associated with the mobile device, a predicted rate of battery disposals associated with the mobile device, a predicted impact of a power consumption of the mobile device on emission rates, or a predicted impact of a power consumption of the mobile device on landfill rates.

Furthermore, in an example, the power consumption diagnostic application 120 may determine device activity data associated with the device 102 based on the compiled event data, and analyze the device activity data using an electrical consumption model to estimate electrical consumption for the device 102 based on battery consumption associated with the device 102. For instance, the electrical consumption model may be a simulation, such as a Monte Carlo simulation, or may be a machine learning model, such as the machine learning model 124. Furthermore, executing the power consumption diagnostic application 120 may include determining at least one metric associated with the estimated electrical consumption. For instance, the metric may be a carbon emission rate metric, a precious metal mining rate metric, or a landfill rate metric.

Moreover, in an example, the power consumption diagnostic application 120 may identify one or more mobile device setting changes, improvements in wireless coverage, application updates, application memory usage changes, application battery usage changes, or behavioral changes impacting the power consumption associated with the mobile device.

Turning now to the trained power consumption diagnostic machine learning model 124, in some examples, the trained power consumption diagnostic machine learning model 124 may be executed on the server device 104, while in other examples the power consumption diagnostic machine learning model 122 may be executed on another computing system, separate from the server device 104. For instance, the server device 104 may send the device data and/or the additional device data to another computing system, where the trained power consumption diagnostic machine learning model 124 is applied to the data corresponding to the device data and/or the additional device data. The other computing system may send a prediction or identification to the server device 104, of one or more of: durations of one or more shifts associated with the mobile device, a required power consumption associated with the mobile device, a measured power consumption associated with the mobile device, a predicted power consumption over time associated with the mobile device, a predicted rate of battery purchases associated with the mobile device, a predicted rate of battery disposals associated with the mobile device, a predicted impact of a power consumption of the mobile device on emission rates, or a predicted impact of a power consumption of the mobile device on landfill rates, based upon applying the trained power consumption diagnostic machine learning model 124 to the device data and/or the additional device data. Moreover, in some examples, the power consumption diagnostic machine learning model 124 may be trained by power consumption diagnostic machine learning model training application 122 executing on the server device 104, while in other examples, the power consumption diagnostic machine learning model 124 may be trained by a machine learning model training application executing on another computing system, separate from the server device 104.

Whether the power consumption diagnostic machine learning model 124 is trained on the server device 104 or elsewhere, the power consumption diagnostic machine learning model 124 may be trained (e.g., by the power consumption diagnostic machine learning model training application 122) using training data from the server device 104, devices 102, and/or databases including historical device data and/or historical additional device data corresponding to historical devices, and durations of one or more historical shifts, historical required power consumption, historical measured power consumption, historical power consumption over time, a historical rate of battery purchases, a historical rate of battery disposals, a historical impact of the power consumption on emission rates, a historical impact of a power consumption on a landfill rate, etc., for the respective historical devices. The trained machine learning model 24 may then be applied to new device data and/or additional device data corresponding to a given device to identify or predict, e.g., durations of one or more shifts, a required power consumption, a power consumption amount, a power consumption over time, a rate of battery purchases, a rate of battery disposals, an impact of the power consumption on emission rates, an impact of a power consumption on a landfill rate, etc., for the device.

In various aspects, the power consumption diagnostic machine learning model 124 may comprise a machine learning program or algorithm that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the power consumption diagnostic machine learning model 124 may comprise a library or package executed on the server device 104 (or other computing devices not shown in FIG. 1). For example, such libraries may include, but are not limited to, the TENSORFLOW based library, the PYTORCH library, and/or the SCIKIT-LEARN Python library.

Machine learning, as referenced herein, may involve identifying and recognizing patterns in existing data (such as training a model 124 based upon historical device data and/or historical additional device data corresponding to historical devices, historical device data and/or historical additional device data corresponding to historical devices, and durations of one or more historical shifts, historical required power consumption, historical measured power consumption, historical power consumption over time, a historical rate of battery purchases, a historical rate of battery disposals, a historical impact of the power consumption on emission rates, a historical impact of a power consumption on a landfill rate, etc., for the respective historical devices, etc.) in order to facilitate making predictions or identification for subsequent data (such as using the machine learning model 124 on new device data and/or additional device data corresponding to a given device to identify or predict, e.g., durations of one or more shifts, a required power consumption, a power consumption amount, a power consumption over time, a rate of battery purchases, a rate of battery disposals, an impact of the power consumption on emission rates, an impact of a power consumption on a landfill rate, etc., for the device).

Machine learning model(s) may be created and trained based upon example data (e.g., “training data”) inputs or data (which may be termed “features” and “labels”) to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided to subsequent inputs for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

In addition, memories 118 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. It should be appreciated that one or more other applications may be envisioned and that are executed by the processor(s) 116. It should be appreciated that given the state of advancements of mobile computing devices, the processes, functions, and steps described herein as being performed by the server device 104 may be performed by a mobile computing device, such as the electronic device 102, or a smart battery, such as the battery 108.

### Example Electronic Device

FIG. 2 is a block diagram associated with an example electronic device 102 as may be used in the system 100 of FIG. 1, in accordance with some embodiments. As shown at block 202, the electronic device 102 (and/or the battery 108 of the electronic device 102) may capture/receive data associated with the battery 108 and/or the device 102. For instance, in some examples, the smart battery 108 may include a fuel gauge to determine the health of the battery, and may determine the battery's state of charge (SOC). Furthermore, the smart battery 108 may capture indications of battery events, and may store an indication of an identification of the battery 108. Additionally, the electronic device 102 may capture all of the data above, as well as a time stamp (e.g., associated with the indications of battery events), smart battery data, and other device data including screen brightness and screen time out settings (in some cases, with associated time stamps), measurements of screen on time, and other data to reduce power usage of the device 102. A communication system 204, which may facilitate a wired or wireless connection between the electronic device 102 and the server 104, may send the data associated with the battery 108 and/or the device 102 to the server 104.

As shown at block 206, the server 104 may analyze the data associated with the battery 108 and/or the device 102 to determine the power usage of the devices 102, and/or usage information, to determine how much power may be required by the devices 102 for user shifts.

Furthermore, as shown at block 208, the server 104 may analyze the data associated with the battery 108 and/or the device 102, as well as the determined power usage of the devices 102 and/or power required by the devices 102 for the user shifts, to determine ways to reduce the rate of battery buying and/or battery disposal. This may include, for instance, determining a delta in baseline consumptions after power saving recommendations are implemented by the devices 102, and/or determining a reduction in the rate of batteries acquired per year and/or disposed of per year after power saving recommendations are implemented by the devices 102.

As shown at block 210, the server 104 may access published or projected data related to the production and/or disposal of smart batteries, including equivalent carbon emissions associated with the production of lithium-ion batteries, and the impact of production and disposal on landfills.

As shown at block 212, using the data from block 210, the server 104 may determine numerical metrics associated with the delta in baseline consumptions after power saving recommendations are implemented by the devices 102, and/or reduction in the rate of batteries acquired per year and/or disposed of per year after power saving recommendations are implemented by the devices 102, as determined at block 208. In particular, as shown at block 212, the server 104 may determine a reduction in carbon emission rates, a reduction in the mining of precious metals, a reduction in the use of landfills, etc., corresponding to the delta in baseline consumptions after power saving recommendations are implemented by the devices 102, and/or reduction in the rate of batteries acquired per year and/or disposed of per year after power saving recommendations are implemented by the devices 102.

### Example Server Device

FIG. 3 is a block diagram associated with an example server device 104 as may be used in the system 100 of FIG. 1, in accordance with some embodiments. As shown in FIG. 3, the server device 104 may include a communication system 302, which may facilitate a wired or wireless connection between the server 104 and the electronic device 102, and may receive the data associated with the battery 108 and/or the device 102 from the battery 108 and/or the device 102. For instance, as shown at block 304, the data associated with the battery 108 and/or the device 102 may include time stamps, smart battery metrics, device usage metrics, device metrics indicative of features impacting power volumes, etc.

The server device 104 may further receive published or projected data associated with the production and/or disposal of device smart batteries, as shown at block 306. For instance, this data may include equivalent carbon emissions in the production of a lithium-ion battery, and/or the impact in production and disposal of such batteries.

The server device 104 may in turn store the data from blocks 302 and 304 on the memory 118. For instance, this data may be stored as event data, battery data, usage data, emission data, and/or disposal impact data associated with one or more electronic devices 102. The server device 104 may analyze the data stored on the memory 118 using one or more simulations (e.g., Monte Carlo simulations) or machine learning models (e.g., machine learning model 124 discussed in greater detail above). As shown at block 308, the server 104 may determine the power used by the devices 102 and the power delta if power saving recommendations are implemented by users of the devices 102, as well as the reduction in battery buying/disposal rates if power saving recommendations are implemented by users of the devices 102, and/or carbon emission and landfill reductions if power saving recommendations are implemented by users of the devices 102.

Furthermore, the server 104 may generate recommended device setting changes or behavioral changes impacting battery power consumption, and may an indication of transmit these recommended device setting changes or behavioral changes directly to the respective devices 102 or to an intermediary associated with the devices 102. For instance, these recommended device setting changes or behavioral changes may be provided to a user of a device 102 as a notification, or may be provided to the device 102 directly as a configuration file or update to the device.

### Example Methods

FIG. 4 illustrates a block diagram of an example process 400 for implementing example methods and/or operations described herein including techniques for tracking and controlling battery consumption in fleets of electronic devices powered by batteries, as may be performed by the system 100 of FIG. 1. For instance, instructions for performing the example process 400 may be stored on a memory of a smart battery 108, stored on the memory 112, and/or stored on the memory 118, and executed by a processor of the smart battery 108, the processor 110, and/or the processor 116 respectively.

At block 402, device metrics associated with an electronic device 102 may be captured to measure power consumption (e.g., total accumulated charge and time stamp), and usage information (e.g., battery discharge rates, screen on time, scan rates, business application usage, etc.) associated with the electronic device 102 may be captured to determine the power required for the user of the electronic device 102 to complete a work shift without disruption.

At block 404, algorithms (such as simulation algorithms and machine learning algorithms, as discussed above) may be used to determine a power consumption range for a work shift using the electronic device 102, defining the minimum charge for the battery 108 of the device 102 to be properly charged at the start of the work shift in order to complete the work shift without disruption.

At block 406, data associated with battery swaps for the device 102 may be analyzed to identify battery swaps where properly charged batteries 108 did not allow the device 102 to complete the work shift without disruption (as compared to battery swaps that resulted from improperly charged batteries 108, and completely unnecessary battery swaps).

At block 408, a baseline power usage of the device 102 may be determined.

At block 410, algorithms (such as simulation algorithms and machine learning algorithms, as discussed above) may be used to analyze the data from block 406 to determine major causes of excess usage impact (e.g., brightness, screen on time, etc.).

At block 412, one or more recommendations for lowering power usage may be implemented.

At block 414, the power usage for the device 102 after implementing the recommendations at block 412 may be determined.

At block 416, a delta between the power usage determined at block 408 and the power usage determined at block 414 may be determined.

At block 418, the impact of the delta determined at block 416 on battery life and the rate of battery buying and disposal may be determined.

At block 420, the impact of the delta determined at block 416 on reduced power consumption rates from electricity service providers may be determined.

At block 422, the impact on carbon emission rates, precious metal mining rates, landfill usage, etc., may be determined based on the impacts determined at blocks 418 and 420.

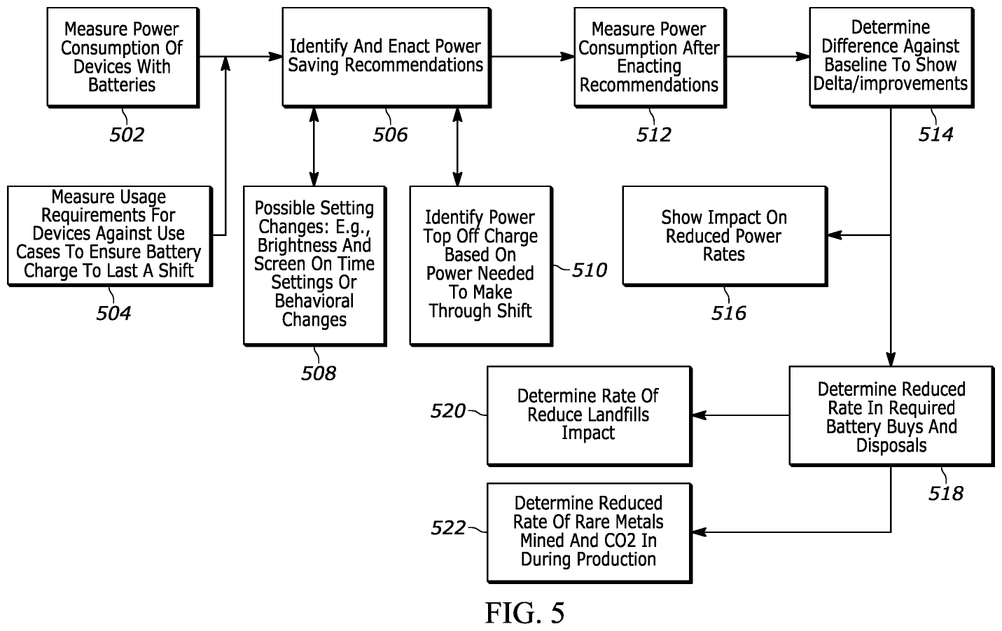

FIG. 5 illustrates a block diagram of an example process 500 for implementing example methods and/or operations described herein including techniques for tracking and controlling battery consumption in fleets of electronic devices powered by batteries, as may be performed by the system 100 of FIG. 1. For instance, instructions for performing the example process 500 may be stored on a memory of a smart battery 108, stored on the memory 112, and/or stored on the memory 118, and executed by a processor of the smart battery 108, the processor 110, and/or the processor 116 respectively.

At block 502, power consumption of devices 102 with batteries may be measured.

At block 504, usage requirements of the devices 102 may be measured and compared against use cases (e.g., work shifts) in order to ensure that the batteries for the devices 102 last an entire shift.

At block 506, power saving recommendations for the devices 102 may be identified and enacted.

At block 508, possible settings changes, such as brightness changes or screen-on time changes or behavioral changes may be identified and/or enacted.

At block 510, a power top off charge based on the power needed for a work shift may be determined.

At block 512, the power consumption after enacting the recommendations at blocks 506, 508, and 510 may be measured.

At block 514, a difference between the power consumption measured at block 512 and the power consumption measured at block 512 may be determined.

At block 516, an impact based on the reduced power rates may be determined and shown.

At block 518, a reduction in battery buying and disposals may be determined based on the impact determined at block 516.

At block 520, a rate of reduced landfill impact may be determined based on the reduction of battery buying and disposals determined at block 518.

At block 522, a rate of reduced rare earth metals mined, and reduced carbon emissions, may be determined based on the reduction of battery buying and disposals determined at block 518.

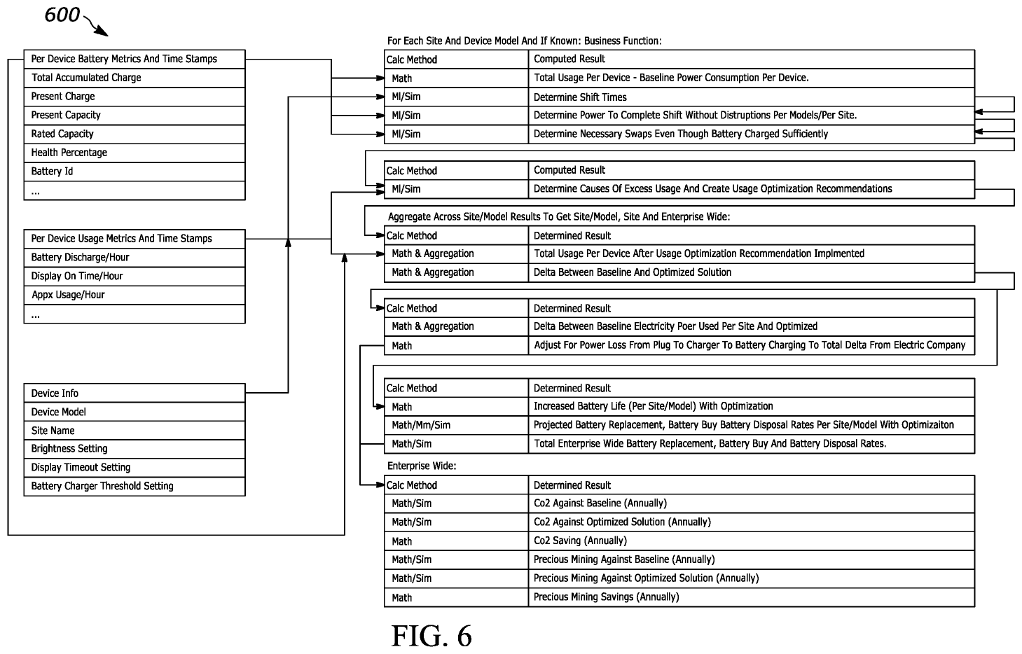

FIG. 6 illustrates a block diagram of an example process 600 for implementing example methods and/or operations described herein including techniques for tracking and controlling battery consumption in fleets of electronic devices powered by batteries, as may be performed by the system 100 of FIG. 1. For instance, instructions for performing the example process 600 may be stored on a memory of a smart battery 108, stored on the memory 112, and/or stored on the memory 118, and executed by a processor of the smart battery 108, the processor 110, and/or the processor 116 respectively.

In particular, FIG. 6 illustrates a process 600 including example inputs and outputs for the determinations discussed with respect to FIGS. 4 and 5 above, particularly with respect to blocks 404-410, and 414-420 from FIG. 4, and blocks 514, and 518-522 from FIG. 5.

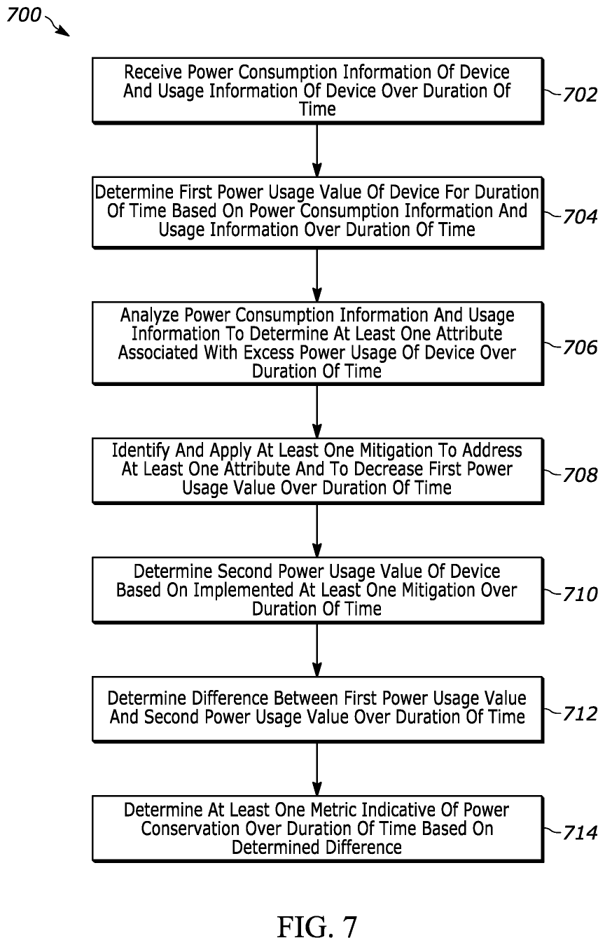

FIG. 7 illustrates a block diagram of an example process 700 for implementing example methods and/or operations described herein including techniques for tracking and controlling battery consumption in fleets of electronic devices powered by batteries, as may be performed by the system 100 of FIG. 1. For instance, instructions for performing the example process 700 may be stored on a memory of a smart battery 108, stored on the memory 112, and/or stored on the memory 118, and executed by a processor of the smart battery 108, the processor 110, and/or the processor 116 respectively.

At block 702, power consumption information of a device and usage information of the device over a duration of time may be received. In some examples, the duration of time is a duration associated with a work shift. For instance, the power consumption information may include battery charge data over the duration of time. Additionally, for example, the usage information may include one or more of: a battery discharge rate, a screen on time, screen brightness data, a scan rate, usage data associated with one or more business applications installed on the device, a battery cycle, a battery charge level, a battery temperature, a battery present capacity, a battery total cumulative charge, a battery rated capacity, an average current, an average power, a voltage, charge on/off events, a battery charge source, or battery swap data, over the duration of time.

At block 704, a first power usage value of the device for the duration of time may be determined, based on the power consumption information and the usage information over the duration of time. For instance, the first power usage value may be a minimum battery charge required over the duration of time. In some examples, determining the first power usage value of the device for the duration of time may be further based on one or more of: a battery type, a battery health, a device type, a device screen timeout setting, a device brightness setting, battery cycle, a battery charge level, a battery temperature, a battery present capacity, a battery total cumulative charge, a battery rated capacity, an average current, an average power, a voltage, charge on/off events, a battery charge source, or a site name, associated with the device.

At block 706, the power consumption information and the usage information may be analyzed to determine at least one attribute associated with excess power usage of the device over the duration of time. For instance, the at least one attribute associated with the excess power usage of the device over the duration of time may include one or more of: a screen brightness attribute, a screen on time attribute, a wireless signal strength attribute, a device location attribute, a device physical memory attribute, an application physical memory utilization attribute, a battery per application utilization attribute, a scanner usage attribute, a data transmission attribute associated with the device, a data transmission per application attribute, a reception usage attribute associated with the device, and a reception usage per application attribute.

At block 708, at least one mitigation may be identified, and applied, to address the at least one attribute and to decrease the first power usage value over the duration of time. For instance, the at least one mitigation may include one or more of: a screen brightness reduction, a screen on time reduction, increasing wireless signal strength quality, improving memory utilization associated with the device, improving memory utilization per application, reducing battery usage per application, optimizing data transmission, optimizing reception, or optimizing scanner usage.

At block 710, a second power usage value of the device may be determined based on the implemented at least one mitigation over the duration of time.

At block 712, a difference between the first power usage value and the second power usage value over the duration of time may be determined.

At block 714, at least one metric indicative of power conservation over the duration of time may be determined based on the determined difference. The at least one metric indicative of power conservation over the duration of time may include one or more of: a battery life metric, a battery purchasing metric, a battery disposal metric, a power consumption metric, a CO2 emission rate metric, or a precious metal mining rate metric.

### Additional Considerations

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope o present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method comprising
receiving power consumption information of a device and usage information of the device over a duration of time;
determining a first power usage value of the device for the duration of time based on the power consumption information and the usage information over the duration of time;
analyzing the power consumption information and the usage information to determine at least one attribute associated with excess power usage of the device over the duration of time;
identifying and applying at least one mitigation to address the at least one attribute and to decrease the first power usage value over the duration of time;
determining a second power usage value of the device based on the implemented at least one mitigation over the duration of time;
determining a difference between the first power usage value and the second power usage value over the duration of time; and
determining at least one metric indicative of power conservation over the duration of time based on the determined difference.

2. The method of claim 1, wherein the power consumption information includes battery charge data over the duration of time.

3. The method of claim 1, wherein the usage information includes one or more of: a battery discharge rate, a screen on time, screen brightness data, a scan rate, usage data associated with one or more business applications installed on the device, a battery cycle, a battery charge level, a battery temperature, a battery present capacity, a battery total cumulative charge, a battery rated capacity, an average current, an average power, a voltage, charge on/off events, a battery charge source, or battery swap data, over the duration of time.

4. The method of claim 1, wherein determining the first power usage value of the device for the duration of time is further based on one or more of: a battery type, a battery health, a device type, a device screen timeout setting, a device brightness setting, battery cycle, a battery charge level, a battery temperature, a battery present capacity, a battery total cumulative charge, a battery rated capacity, an average current, an average power, a voltage, charge on/off events, a battery charge source, or a site name, associated with the device.

5. The method of claim 1, wherein the first power usage value is a minimum battery charge required over the duration of time.

6. The method of claim 1, wherein the at least one attribute associated with the excess power usage of the device over the duration of time includes one or more of: a screen brightness attribute, a screen on time attribute, a wireless signal strength attribute, a device location attribute, a device physical memory attribute, an application physical memory utilization attribute, a battery per application utilization attribute, a scanner usage attribute, a data transmission attribute associated with the device, a data transmission per application attribute, a reception usage attribute associated with the device, and a reception usage per application attribute.

7. The method of claim 1, wherein the at least one mitigation includes one or more of: a screen brightness reduction, a screen on time reduction, increasing wireless signal strength quality, improving memory utilization associated with the device, improving memory utilization per application, reducing battery usage per application, optimizing data transmission, optimizing reception, or optimizing scanner usage.

8. The method of claim 1, wherein the at least one metric indicative of power conservation over the duration of time includes one or more of: a battery life metric, a battery purchasing metric, a battery disposal metric, a power consumption metric, a CO2 emission rate metric, or a precious metal mining rate metric.

9. The method of claim 1, wherein the duration of time is a duration associated with a work shift.

10. A system comprising:
a device including:
a smart battery including a battery memory and one or more battery processors storing first computer-readable instructions that cause the one or more battery processors to store battery usage and state of charge (SOC) data on the battery memory;
a clock,
a device communication system,
one or more device processors, and
a device memory storing second computer-readable instructions; and
a server including a server communication system, one or more server processors, and a server memory storing third computer-readable instructions;
wherein the second computer-readable instructions, when executed by the one or more device processors, cause the one or more device processors to:
detect events associated with the battery;
compile event data based on the detected events, the event data including, for each of one or more detected events, one or more of: battery usage data stored on the battery memory associated with the event, SOC data stored on the memory associated with the event, an indication of an event type associated with the event, a time associated with the event, an indication of a backup voltage level during the event, a battery temperature associated with the event, a battery cumulative charge at the time of the event, or a battery charge source associated with the event; and
transmit the compiled event data to the server, via the device communication system;
wherein the third computer-readable instructions, when executed by the one or more server processors, cause the one or more server processors to:
receive the compiled event data from the device, via the server communication system;
determine device activity data associated with the device based on the compiled event data; and
analyze the device activity data using an electrical consumption model to estimate electrical consumption for the device based on battery consumption associated with the device.

11. The system of claim 10, wherein the device is one of: a mobile computing device, a mobile printer, a scanner device, and a robot device.

12. The system of claim 10, wherein the second computer-readable instructions, when executed by the one or more device processors, further cause the one or more device processors to:
capture additional device data including one or more of: power usage data associated with the device, a screen on time associated with the device, screen brightness data associated with the device, a scan rate associated with the device, usage data associated with one or more business applications installed on the device, a wireless signal strength associated with the device, a device location, an indication of device physical memory utilization, an indication of physical memory utilization per application, an indication of battery utilization per application, an indication of data transmission associated with the device, an indication of data transmission per application, an indication of reception usage associated with the device, or an indication of reception usage per application; and
transmit, via the device communication system, the additional device data to the server.

13. The system of claim 12, wherein the third computer-readable instructions, when executed by the one or more server processors, further cause the one or more server processors to:
receive the additional device data, via the server communication system; and
determine the device activity data based further on the additional device data.

14. The system of claim 10, wherein the third computer-readable instructions, when executed by the one or more server processors, further cause the one or more server processors to:
determine at least one metric associated with the estimated electrical consumption, the at least one metric including one or more of: an emission rate, a precious metal mining rate, or a landfill rate.

15. The system of claim 10, wherein the detected events associated with the battery include one or more of: a low battery event battery, a battery swap mode event, a battery swap entry event, a battery swap exit event, a battery change on event, a battery charge off event, a battery status event, a battery temperature event, a battery cumulative charge event, a device suspend event, a device suspend recovery event, or a device shutdown event.

16. A system comprising:
a mobile device including a battery, a clock, a mobile device communication system, one or more mobile device processors, and a mobile device memory storing first computer-readable instructions that, when executed by the one or more mobile device processors, cause the one or more mobile device processors to collect and transmit mobile device data, including battery and usage status data, via the mobile device communication system;
a server including a server communication system, one or more server processors, and a server memory storing second computer-readable instructions that, when executed by the one or more server processors, cause the one or more server processors to:
receive mobile device data, via the server communication system;
analyze the mobile device data to determine one or more of: durations of one or more shifts associated with the mobile device, a required power consumption associated with the mobile device, a measured power consumption associated with the mobile device, a predicted power consumption over time associated with the mobile device, a predicted rate of battery purchases associated with the mobile device, a predicted rate of battery disposals associated with the mobile device, a predicted impact of a power consumption of the mobile device on emission rates, or a predicted impact of a power consumption of the mobile device on landfill rates.

17. The system of claim 16, wherein the mobile device is one of: a mobile computing device, a mobile printer, a scanner device, or a robot device.

18. The system of claim 16, wherein the battery is a lithium-ion battery.

19. The system of claim 16, wherein analyzing the mobile device data includes analyzing the mobile device data using one or more machine learning algorithms.

20. The system of claim 16, wherein analyzing the mobile device data includes analyzing the mobile device data using one or more simulations.

21. The system of claim 20, wherein the one or more simulations include a Monte-Carlo simulation.

22. The system of claim 16, wherein the second computer-readable instructions, when executed by the one or more server processors, further cause the one or more server processors to:
identify one or more mobile device setting changes, improvements in wireless coverage, application updates, application memory usage changes, application battery usage changes, or behavioral changes impacting the power consumption associated with the mobile device.
